(19) United States
(12) Patent Application Publication
(10) Pub. No.: US 2013/0093915 A1
(43) Pub. Date: Apr. 18, 2013

(54) Multi-Illuminant Color Matrix Representation and Interpolation Based on Estimated White Points

(71) Applicants: Xuemei Zhang, Mountain View, CA (US); Yingjun Bai, San Jose, CA (US); Paul Hubel, Mountain View, CA (US)

(72) Inventors: Xuemei Zhang, Mountain View, CA (US); Yingjun Bai, San Jose, CA (US); Paul Hubel, Mountain View, CA (US)

(73) Assignee: APPLE INC., Cupertino, CA (US)

(21) Appl. No.: 13/342,879

(22) Filed: Jan. 3, 2012

Related U.S. Application Data
(60) Provisional application No. 61/546,139, filed on Oct. 12, 2011.

(51) Int. Cl. H04N 9/73; G06K 9/00

(52) U.S. Cl. 348/223.1; 382/167; 348/E09.051

(57) ABSTRACT

This disclosure pertains to devices, methods, and computer readable media for improved accuracy of color correction matrix (CCM) coefficient determination based on estimated white point, while maintaining a relatively smooth variation of CCM coefficients over the white point space. The techniques disclosed herein may be achieved via the storage of a limited number of determined CCM multiplier vectors and thus be effective in the camera image pipelines of real image capture devices. With the more accurate CCMs calculated with the disclosed techniques, visible improvement in rendered colors may be achieved as compared to using interpolation from a handful of corner CCMs. The color correction techniques described herein may be implemented by dedicated or general purpose hardware, general application software, or a combination of software and hardware in a computer system.

### CROSS-REFERENCE TO RELATED APPLICATION

This application claims priority to U.S. Provisional Patent Application Ser. No. 61/546,139, filed Oct. 12, 2011, which is hereby incorporated by reference in its entirety.

### BACKGROUND

This disclosure relates generally to the field of color correction. More particularly, but not by way of limitation, it relates to techniques for deriving improved approximation and interpolation of color correction matrices based on using a multi-illuminant color matrix representation and interpolation based on estimated white points.

In image processing, color correction may be thought of as going hand-in-hand with color balancing. Color balancing may be described as the global adjustment of the intensities of the colors in an image. One goal of color balancing is to render specific colors, e.g., neutral white, as accurately as possible to the way the color appeared in the actual physical scene from which the image was captured. In the case of rendering neutral white colors correctly, the process is often referred to as “white balancing,” Most digital cameras base their color balancing and color correction decisions at least in part on the type of scene illuminant. For example, the color of a white sheet of paper will appear differently under fluorescent lighting than it will in direct sunlight. The type of color balancing to be performed on an image may be specified manually by a user of the digital camera who knows the scene illuminant for the captured image, or may be set programmatically using one or more of a variety of auto white balance (AWB) algorithms to estimate a scene white point.

In addition to the color balancing that may be provided, e.g., by AWB algorithms, there may still be a need to correct the colors in an image before the image is displayed to a user. “Color correction” may thus involve the transformation of the image pixel data from the (optionally color-balanced) RGB values captured by the camera image sensor into RGB values that render all colors (not just whites) as accurately as possible by maximizing their colorimetric accuracy, i.e., by matching perceived appearance to the human eye. In some embodiments, these subsequent color corrections may be imposed via the application of a “color correction matrix,” or CCM, to the image pixel data.

CCMs for a typical consumer camera are usually tuned for individual illuminants to maximize their colorimetric accuracy. For a three-color camera of poor colorimetric quality (as is typical of most mobile cameras), the number of different color matrices that may be required to cover common illuminants can vary from 20 to more than 100, depending on the target color accuracy. With a known illuminant, the CCM can be optimized to within 1-2 ΔE in color reproduction error (ΔE is a standard color difference measure representing the human threshold of detection). In real camera products, however, scene illuminants are not known a priori, and thus, must be estimated from image data and capture parameters. With most practical white balance methods, only the white point itself (i.e., the camera's raw response to the illuminant) is estimated, and the most appropriate color correction matrix is selected based only on the estimated white point, which inevitably suffers from estimation errors. Further, it may be undesirable to store hundreds of possible CCMs in memory onboard a mobile device.

One commonly-practiced CCM selection solution involves using a look-up table (LUT) linking particular white points to particular CCMs. This type of solution may be effective when similar white points are associated with similar CCMs. However, it is not uncommon for illuminants of very different spectral power distributions (and thus different optimal CCMs) to have similar or even identical white points. If a simple LUT is used in such cases, even a small change in white point estimation could result in very different CCM selections, leading to visible jumps in rendered color appearance that are not desirable.

MVPs an alternative to LUTs, another commonly-practiced CCM selection solution is to select a smaller number of color matrices optimized for “representative” illuminants that correspond to the extreme coordinates of white points for a camera, and then derive the CCMs corresponding to other white points through interpolation in between the selected color matrices. This interpolation-based method of CCM selection is simple and economical in storage and in computation, while theoretically allowing a smooth and gradual change of color matrix coefficients when white points change slightly. However, this approach suffers from a loss of colorimetric accuracy. Empirical evidence gathered by the inventors has revealed that the optimal CCM coefficients do not always vary smoothly between “corner” matrices (in this case, “corner” matrix refers to a CCM corresponding to a particular extreme white point coordinate for the camera), thus approximation through interpolation among a handful (e.g., two to four) of corner matrices will not always give satisfactory results. For example, with the poor approximation that may be achieved through interpolating between four exemplary corner matrices, color reproduction error can be blown up to 5-6 ΔE in real usage, even though the CCMs optimized for individual illuminants have been optimized to within 1-2 ΔE.

Accordingly, there is a need for techniques to provide for improved accuracy of CCM coefficient determination based on estimated white point, while maintaining a relatively smooth variation of CCM coefficients over the white point space. The techniques disclosed herein may be achieved via the storage of a limited number of CCM multiplier vectors and thus be effective in the camera image pipelines of real image capture devices. With the more accurate CCMs calculated with the disclosed techniques, visible improvement in rendered colors may be achieved as compared to using interpolation from a handful of corner CCMs.

### SUMMARY

This disclosure pertains to devices, methods, and computer readable media for implementing a more effective CCM coefficient determination approach based on an estimated scene white point. In some embodiments, the techniques disclosed herein may be used to determine, a priori, a set of CCM multiplier vectors that can best approximate the individual CCMs optimized for a set of known common illuminants when multiplied with coefficients determined from white point and scene lux information. During such a deterministic process, the set of CCM multiplier vectors may essentially serve as a weighting function for a coefficient vector that is derived from an estimated scene white point. In some embodiments, the CCM multiplier vectors are determined such that the coefficient vector may act as a set of polynomial coefficients in order to encourage a relatively smooth transition of CCM coefficients as the estimated white point moves gradually, while still providing sufficient flexibility to represent the variations of CCM coefficients for a large number of CCMs optimized for very different illuminants.

Thus, in one embodiment described herein, a computer-implemented method is disclosed comprising: receiving image pixel data from an image captured by an image sensor of a device; obtaining a set of CCM multiplier vectors (e.g., a pre-calculated set of vectors that is stored in memory), wherein the set of CCM multiplier vectors is representative of a plurality of CCMs for known illuminants; constructing a coefficient vector, wherein the coefficient vector based at least in part on an estimated white point of the image pixel data; multiplying the set of CCM multiplier vectors with the coefficient vector to generate a CCM for the estimated white point; and applying the CCM for the estimated white point to the image pixel data to transform the image pixel data into color-corrected image pixel data.

In another embodiment described herein, a computer-implemented method is disclosed comprising: obtaining a set of CCM multiplier vectors, wherein the set of CCM multiplier vectors comprises a set of values resulting from an deterministic process; constructing a coefficient vector, wherein the coefficient vector is based at least in part on an estimated white point of image pixel data; multiplying the set of CCM multiplier vectors with the coefficient vector to generate a CCM for the estimated white point; and applying the CCM for the estimated white point to the image pixel data to transform the image pixel data into color-corrected image pixel data.

Novel and improved techniques for improving the accuracy of CCM coefficient determination for a particular white point in accordance with the various embodiments described herein are readily applicable to any number of electronic image capture devices with appropriate image sensors, such as mobile phones, personal data assistants (PDAs), portable music players, digital cameras, as well as laptop and tablet computer systems.

### BRIEF DESCRIPTION OF THE DRAWINGS

FIG. 1A illustrates a perceptual model for correcting camera response to the sensitivity of the human eye, in accordance with prior art teachings.

FIG. 1B illustrates an abstractive and conceptual image processing pipeline or performing color correction, in accordance with prior art teachings.

FIG. 2 illustrates an improved image processing pipeline for performing color correction utilizing a multi-illuminant color matrix representation and interpolation based on estimated white point, in accordance with one embodiment.

FIG. 3 illustrates in greater detail a process for performing color correction utilizing a multi-illuminant color matrix representation and interpolation based on estimated white point, in accordance with one embodiment.

FIG. 4 illustrates a system for generating a color correction matrix utilizing a multi-illuminant color matrix representation and interpolation based on estimated white point in logical flowchart form, in accordance with one embodiment.

FIG. 5 illustrates a simplified functional block diagram of a representative electronic device possessing a display and an image sensor.

### DETAILED DESCRIPTION

In the interest of clarity, not all features of an actual implementation are described in this specification. It will of course be appreciated that in the development of any such actual implementation (as in any development project), numerous decisions must be made to achieve the developers' specific goals (e.g., compliance with system- and business-related constraints), and that these goals will vary from one implementation to another. It will be further appreciated that such development effort might be complex and time-consuming, but would nevertheless be a routine undertaking for those of ordinary skill having the benefit of this disclosure.

In the following description, for purposes of explanation, numerous specific details are set forth in order to provide a thorough understanding of the inventive concept. As part of the description, some structures and devices may be shown in block diagram form in order to avoid obscuring the invention. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

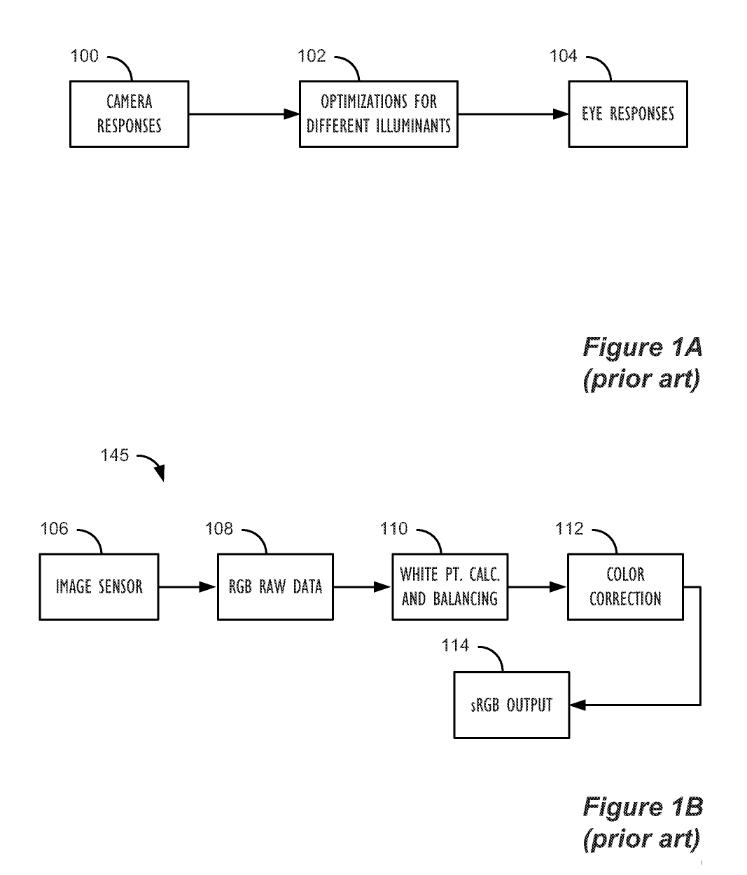

Turning first to FIG. 1A, a perceptual model for correcting camera response to the sensitivity of the human eye is shown for explanatory purposes. At basic level, a camera's image sensor will have characteristic responses 100 to incident light across the entire spectrum of wavelengths to which the image sensor is sensitive. The scene being captured may also be lit by different types of illuminants, which can have an effect on the way that the colors in the scene will be reproduced and perceived by the human eye. Thus, different optimizations 102, such as color balancing and/or color correction, may be employed based on different illuminant types.

If the image sensor's sensitivity is the same as the sensitivity of the human eye across the visible ranges of the human eye, then no further color correction beyond color balancing may be needed; however, if the image sensor's sensitivity and the sensitivity of the human eye are different across the particular range of the human vision, then further color correction, such as the application of a color correction matrix (CCM) may also be employed to the image sensor captured data to ensure the perception of the color by the human eye 104 is as accurate as possible to the real-world scene color. During the color correction process, colors measured in the native three-color (i.e., RGB) image sensor space may be transformed to a standard chromatic space, such as the CIE 1931 XYZ color space, for example, via a linear transformation by means of a CCM. In some embodiments, the CCM may be represented by nine values in the form of a 3×3 matrix of values, such as is shown in Eqn. 1 below:

$$[ \begin{matrix}X \\ Y \\ Z\end{matrix} ] = [ \begin{matrix}Xr & Xg & Xb \\ Yr & Yg & Yb \\ Zr & Zg & Zb\end{matrix} ] [ \begin{matrix}R \\ G \\ B\end{matrix} ] \qquad ( Eqn . 1 )$$

Turning now to FIG. 1B, an abstractive and conceptual image processing pipeline 145 for performing color correction is shown for explanatory purposes. First, the scene is captured by an image sensor 106. Image pixel data is output from the image sensor in RGB raw data format 108 and may be stored and/or accumulated in a suitable color space. According to some embodiments, the color space, or “chromaticity space,” in which the image pixel data is accumulated may be defined by a series of mathematical transformations in order to give the space a particular shape or to result in other desired properties being enforced. Additionally, the transformation parameters may be optimized to adapt to specific sensors' spectral sensitivity. In the example described herein, the chromaticity space will be an affine-transformed log ratio color space, but any other color space may be used, such a color ratio space (e.g., R/G by B/G).

As mentioned above, image sensor information may come into the image processing pipeline 145 from the image sensor in the form of RGB raw data, i.e., an unprocessed linear RGB signal that is not ready for display. In some embodiments, in order to reduce the input signal from three color dimensions (i.e., red, green, and blue) into two color dimensions, the RGB signal may be converted into chrominance values, though such a conversion is not necessary. Chrominance, as used herein, will refer to an objective specification of the quality of a color—independent of its luminance (i.e., brightness). Once luminance has been removed from consideration, the remaining components of a color can be defined by two variables, sometimes referred to as x and y. This is useful, as it allows the chromaticity space to be mapped into a 2D plot where all existing colors may be uniquely identified by an x-y coordinate position in the chromaticity space. In some embodiments, these chrominance values may then be accumulated in a 2D histogram created over the color space, though such a scheme is not necessary.

Once the image pixel data has been transformed into the desired format, a white point for the image may be estimated using any desired white balancing technique, and then the image pixel data may be color balanced, e.g., by using an auto white balance (AWB) algorithm 110 based on the estimated white point. The AWB algorithm 110 may be used to determine if the gains of any of the R, G, or B channels need to be adjusted so that a white pixel renders as white. Any of a number of possible white balance algorithms may be used, such a gray world algorithm, selective gray world algorithm, or weighted accumulator algorithm, as are understood by those of skill in the art. Next, depending on scene lux levels and the type of illuminant, further color correction 112, for example, a CCM, may be applied to the image data. The scene white point, however, is an incomplete description of the scene illuminant. Therefore, two images with the same white point might in fact have different scene illuminants, and therefore could require very different optimized CCMs. Once the image data has been color balanced and color corrected as desired, output data, e.g., in the form of sRGB i.e., standard RGB), may be sent to a desired display device 114.

With this framework in mind, the remainder of the Detailed Description will discuss techniques that may be used to determine more accurate color correction matrix coefficients to be applied to the color balanced image pixel data coming out of white balance process 110 so that color rendering will be more accurate, while still remaining computationally friendly and effective in real world image capture devices. Specifically, the techniques discussed herein will relate to image processing techniques for creating and determining CCM coefficients while maintaining a relatively smooth variation of CCM coefficients over the white point space.

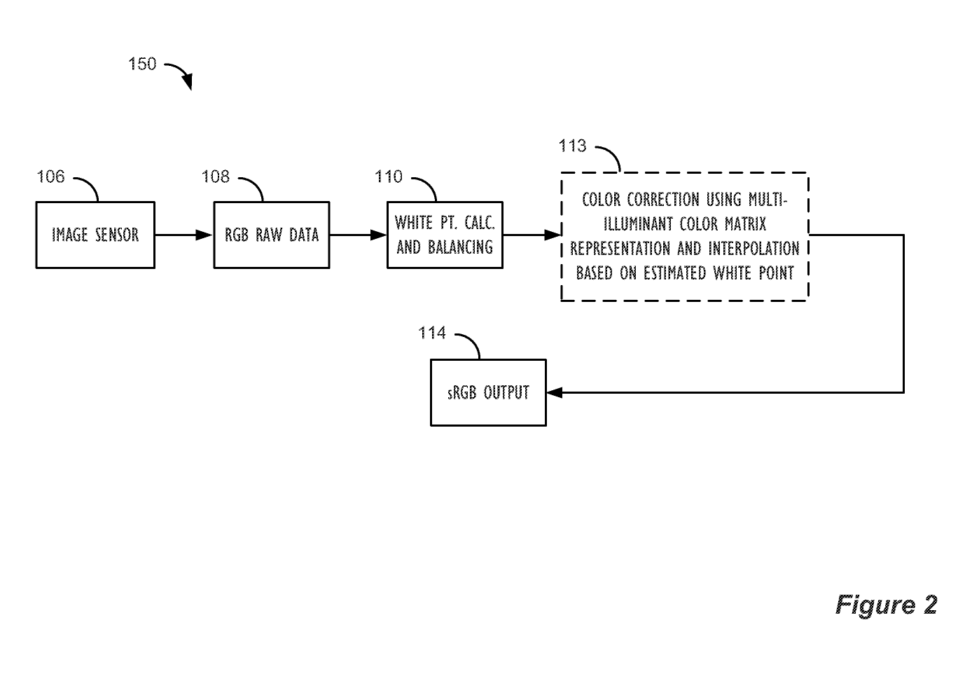

Turning now to FIG. 2, an improved image processing pipeline 150 for performing color correction utilizing a multi-illuminant color matrix representation and interpolation based on estimated white point is illustrated, in accordance with one embodiment. Compared to image processing pipeline 145 shown in FIG. 1B, the improved image processing pipeline 150 has an element 113 labeled “Color Correction Utilizing Multi-Illuminant Color Matrix Representation and Interpolation Based on Estimated White Point” between the receiving of color balanced image data at element 110 and the generation of sRGB output for display at element 114. The color correction of image pixel data via the use of determined CCMs based on estimated white point and using a multi-illuminant color matrix representation 113 will now be described in further detail below.

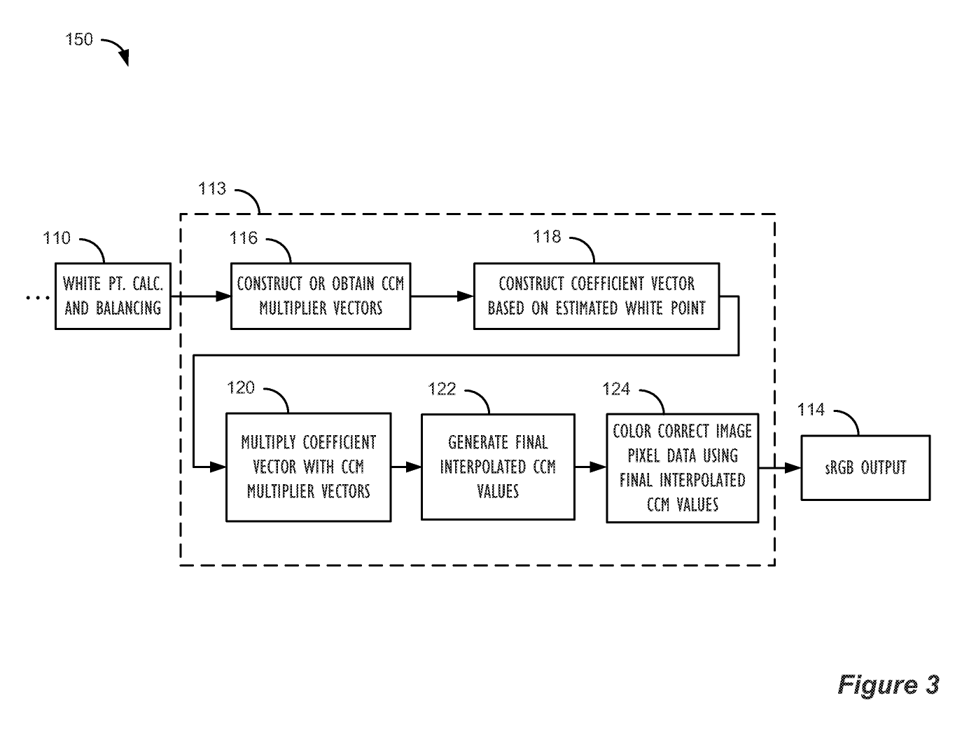

Turning now to FIG. 3, a process 150 for performing color correction utilizing a multi-illuminant color matrix representation and interpolation based on estimated white point is illustrated in greater detail. First, the process may construct (or otherwise obtain) a set of CCM multiplier vectors (Element 116), as will be described in greater detail below. These CCM multiplier vectors may be determined a priori i.e., set for a particular image sensor at the factory) across a set of known common illuminants such that their multiplication with a constructed coefficient vector based on the estimated scene white point (See Element 118) results in a minimal amount of approximation error when used to represent CCMs for all common illuminants, i.e., the process strives to minimize an aggregate error value from CCMs optimized for individual illuminants using standard techniques. The method by which the CCM multiplier vectors are determined is not mandatory, and one exemplary process for performing such a deterministic calculation is described in greater detail below.

As mentioned above, simple interpolation among four corner matrices is not sufficient to represent all CCMs accurately. However, the inventors have recognized that the pattern of variation in the optimized values of the nine CCM coefficients over the white point space are somewhat correlated, suggesting that the underlying dimensionality of the coefficients is limited. Thus, the problem of solving for the representative CCM basis vectors may be treated as a general dimension reduction problem, allowing for the representation of an arbitrary number of CCMs with a limited set of basis vectors.

### Solving for the CCM Basis Vectors

Let Ci be a vector representing the nine entries of the optimized CCM for an illuminant, i. In any particular implementation, the order of the nine numbers in this vector is not important, as long as all the CCMs have their coefficients in the same order. As mentioned above, the problem of CCM interpolation may be treated as a general dimension reduction problem, where the CCM coefficients are represented as a combination of several basis vectors, each of length nine. For reduction of n CCMs corresponding to n illuminants, we look for basis vectors, B (an m×9 matrix), and coefficients A, (an n×m matrix), so that:

B*A˜=C, (Eqn. 2)

where B is an m×9 matrix of basis vectors, A=[A1 A2 . . . An] is an n×m matrix of n sets of weights, and C=[C1 C2 . . . Cn] is an n×9 matrix of n sets of CCM coefficients. The use of the ‘˜=’ notation herein means “approximately equal,” When forcing a basis set of m vectors, it may not be possible to make B*A exactly equal to C (depending on how large m is), but the closest approximation may be chosen using a least-squared-error measure (or some other error measure).

Such a reduction may be performed with singular value decomposition on the matrix C, where the top m singular values are taken to get an approximation:

C˜=B*S*V′ (Eqn. 3).

In this case, B is the basis vector set, and coefficients A=S*V′. The number of basis vectors to keep (m) can be flexible, and may be determined by a combination of accuracy and resource considerations. In one embodiment, it has been found that five basis vectors are usually sufficient for cameras with lower-end colorimetric quality (although the number can be smaller if the camera is nearly colorimetric). The value of m actually does not impact the number of final values needed to represent and calculate the CCMs in field use, as will be explained shortly. However, it is generally advisable to keep m small during this stage to make parameter fitting more stable.

Having the basis set, B, and coefficients, A, however, is not the full solution to the multi-illuminant representation problem. To find the most appropriate CCM for an image, the CCM may be calculated based on the estimated white point of the image. Thus, the next step in the processing pipeline 150 comprises constructing coefficient vectors based on the estimated white point (Element 118).

### Constructing the Coefficient Vectors

White points are typically represented as a pair of two gain values, e.g., R/G and B/G (or as simple functions of these two values). The inventors have discovered that the coefficients in A are adequately predicted by a low order polynomial of the log white point color ratios, e.g.,

A˜=P*[1RgRg²BgBg²]′, (Eqn. 4)

where P is a 5×m matrix of polynomial coefficients; and Rg=f(R/G), Bg=f(B/G), with f(x) being a simple function of the white point color ratios, e.g., a log function. The use of low order (e.g., order four or less) polynomial encourages a smooth transition of CCM coefficients when the white point moves slightly, but provides sufficient flexibility to represent the variations of CCM coefficients for a large number of CCMs optimized for very different illuminants. Combining (Eqn. 2) and (Eqn. 4) above, the final reduced representation of C may be expressed as:

C˜=B*P*[1RgRg²BgBg²]′=Bp*[1RgRg²BgBg²]′, (Eqn. 5)

where Bp is a 5×9 matrix of CCM multiplier vectors, and represents the only set of values that need to be stored onboard the image capture device to adequately represent all CCMs and theft link to white point locations.

Once calculated, the CCM multiplier vectors, Bp, may be multiplied by the coefficient vector, A (Element 120). The result of this multiplication will be to generate a final 1×9 “interpolated” vector of CCM coefficient values (Element 122). The word interpolated is used in quotations because the vector of coefficient values generated by the process detailed above benefits from the a priori knowledge of all common illuminants and their relation to optimized CCMs, as well as the estimated scene white point, thus providing for a more accurately interpolated CCM than a CCM generated using simple “corner matrix interpolation,” as described above. This final 1×9 “interpolated” vector of CCM coefficient values may then be converted to the typical 3×3 matrix format according to a predetermined scheme and then used to color correct the image pixel data (Element 124) before being passed on to a display in the form of sRGB output values (Element 114).

There are other factors that might call for even more variations of CCMs to be used in the camera image processing pipeline 150. One example is the modeling of perceived color desaturation under low light conditions, where different CCMs are sometimes required to generate the more subdued colors when the scene lux level is low. The prevailing practice in the art is to use one or two desaturation matrices that are blended with the regular CCM (i.e., the CCM that was selected based on estimated scene lux level), to generate the final CCM to use for color correction. However, to accurately model the appearance change under different light levels, a different CCM might need to be optimized for each light level and each illuminant type. This can instantly increase the number of CCMs in the pool of CCMs that would need to be stored onboard the device, and often requires cumbersome changes in the color correction process algorithm code to handle the additional interpolations based on light level. With the multi-illuminant matrix representation approach outlined above, however, the addition of low-light desaturation can be handled without changing the fundamental structure of the CCM interpolation in (Eqn. 5) above.

Instead, all that may be needed is the addition of a “lux factor” as another predictor (i.e., a sixth predictor) in the coefficient array, resulting in a representation of the CCM basis vector matrix, C, defined as follows:

C˜=Bp*[1RgRg²BgBg²L^{e}]″, (Eqn. 6)

where L^{e} is a power function of lux level, L, with e being a fitted number based on the particular chromatic adaptation model used when calculating CCM desaturation. The only additional parameter needed to account for lowlight desaturation is the exponent, e, which also increases the size of matrix Bp to 6×9 (rather than 5×9).

With the added “lux factor” predictor added to the coefficient array, the deterministic process as described above may be repeated and carried out to generate a set of CCM multiplier vectors that may then subsequently be used to generate CCMs for all possible illuminant values, as described above.

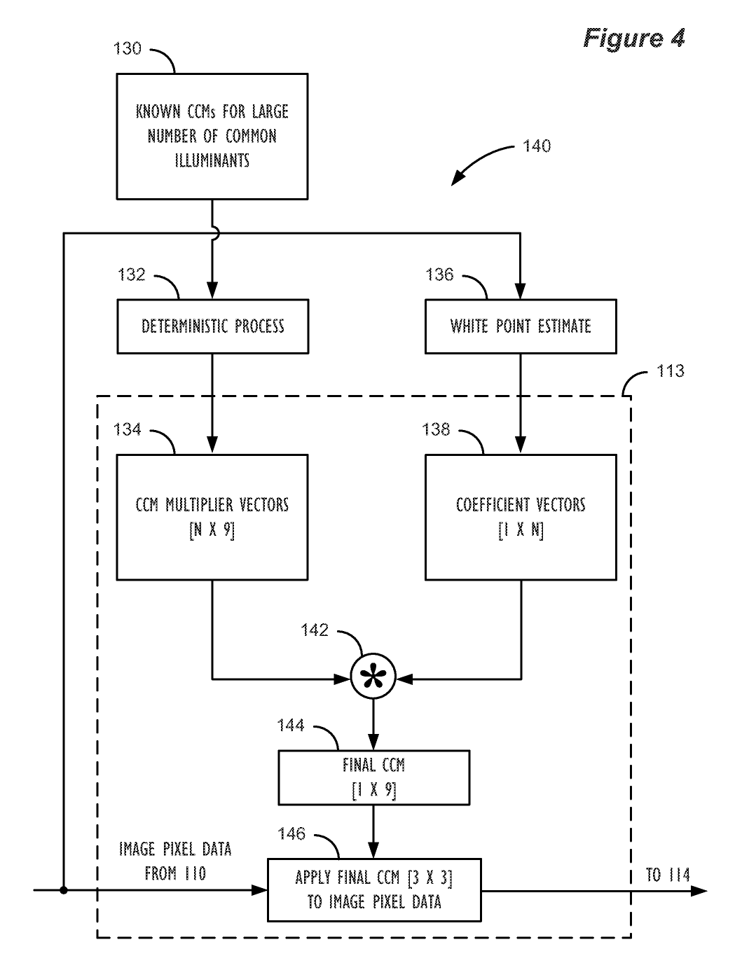

Turning now to FIG. 4, a system 140 for generating a color correction matrix utilizing a multi-illuminant color matrix representation and interpolation based on estimated white point is illustrated in a logical flowchart form, in accordance with one embodiment. The dashed line labeled 113 represents the part of the process that may take place within Element 113 of the improved image processing pipeline 150 for each captured image. The system 140 may use as inputs a collection of known CCMs for a large number of common illuminants (Element 130). From the known CCMs, an deterministic process (Element 132), e.g., a dimension reduction process, may be employed to generate a priori a set of CCM multiplier vectors (Element 134) to be used by process 113. As described above, the CCM multiplier vectors may be derived such that, when multiplied with coefficient vectors representative of all common illuminants, the total error between the generated CCMs and known CCMs for the white points is minimized in the aggregate. System 140 may also provide as input to process 113 an estimated scene white point (Element 136) for each captured image. The estimated scene white point may then be used to construct a coefficient vector (Element 138) according to the desired formula, e.g., a polynomial equation as described in Eqn, 4 above. The coefficient vector constructed from the estimated white point values may then be multiplied (Element 142) with the CCM multiplier vectors (Element 134) to generate a final 1×9 CCM of values (Element 144), which may then be reformatted according to a predetermined scheme as a 3×3 CCM (Element 146) and applied to the image pixel data, resulting in image pixel data in a suitable display format, e.g., sRGB (Element 114).

Thus, it may be seen that the system 140 has effectively turned what was the need to store hundreds of common illuminant CCMs into the need to store only a single set of CCM multiplier vectors. In the case of a 6×9 matrix of CCM multiplier vectors, then, it may be understood that only 54 values need to be stored to represent all possible CCMs. Further, the use of polynomial coefficients in the weighting vector (See Element 138) means that there will be a smooth transition between the CCMs generated for estimated scene white points that are close to one another.

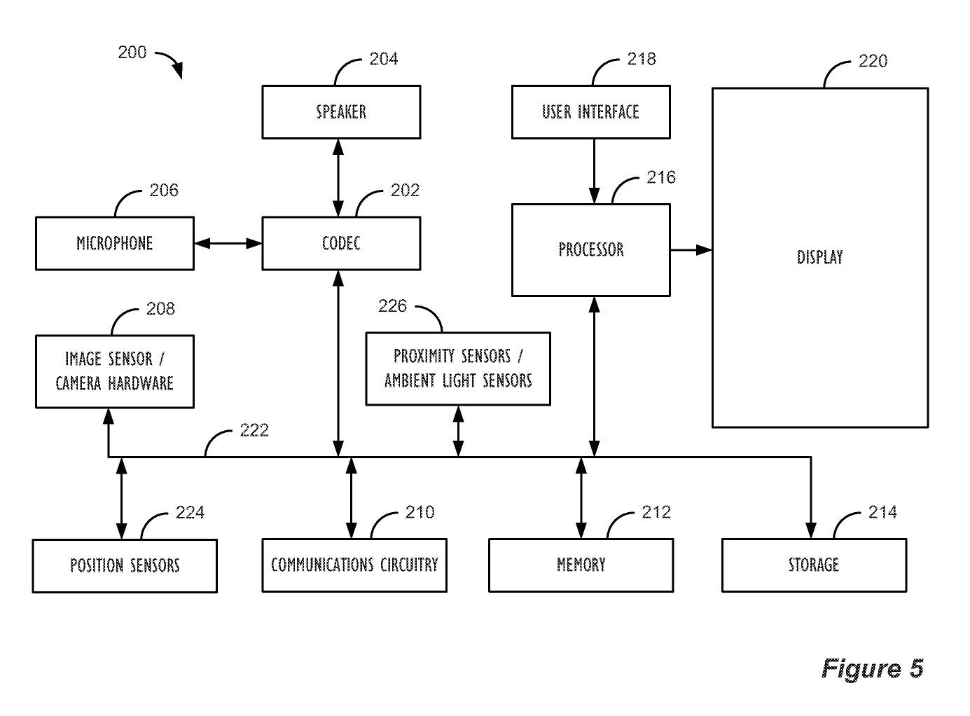

Referring now to FIG. 5, a simplified functional block diagram of a representative electronic device possessing a display 200 according to an illustrative embodiment, e.g., electronic image capture device 200, is shown. The electronic device 200 may include a processor 216, display 220, proximity sensor/ambient light sensor 226, microphone 206, audio/video codecs 202, speaker 204, communications circuitry 210, position sensors 224 (e.g., accelerometers or gyrometers), image sensor with associated camera hardware 208, user interface 218, memory 212, storage device 214, and communications bus 222. Processor 216 may be any suitable programmable control device and may control the operation of many functions, such as the generation and/or processing of image metadata, as well as other functions performed by electronic device 200. Processor 216 may drive display 220 and may receive user inputs from the user interface 218. An embedded processor provides a versatile and robust programmable control device that may be utilized for carrying out the disclosed techniques.

Storage device 214 may store media (e.g., image and video files), software (e.g., for implementing various functions on device 200), preference information, device profile information, and any other suitable data. Storage device 214 may include one more storage mediums for tangibly recording image data and program instructions, including for example, a hard-drive, permanent memory such as ROM, semi-permanent memory such as RAM, or cache. Program instructions may comprise a software implementation encoded in any desired language (e.g., C or C++).

Memory 212 may include one or more different types of memory which may be used for performing device functions. For example, memory 212 may include cache, ROM, and/or RAM. Communications bus 222 may provide a data transfer path for transferring data to, from, or between at least storage device 214, memory 212, and processor 216. User interface 218 may allow a user to interact with the electronic device 200. For example, the user input device 218 can take a variety of forms, such as a button, keypad, dial, a cock wheel, or a touch screen.

In one embodiment, the personal electronic device 200 may be an electronic device capable of processing and displaying media, such as image and video files. For example, the personal electronic device 200 may be a device such as such a mobile phone, personal data assistant (PDA), portable music player, monitor, television, laptop, desktop, and tablet computer, or other suitable personal device.

The foregoing description of preferred and other embodiments is not intended to limit or restrict the scope or applicability of the inventive concepts conceived of by the Applicants. As one example, although the present disclosure focused on handheld personal electronic image capture devices, it will be appreciated that the teachings of the present disclosure can be applied to other implementations, such as traditional digital cameras. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A non-transitory program storage device, readable by a programmable control device comprising instructions stored thereon for causing the programmable control device to perform a method comprising the acts of:
receiving image pixel data from an image captured by an image sensor of a device;
obtaining a set of color correction matrix (CCM) multiplier vectors, wherein the set of CCM multiplier vectors is representative of a plurality of CCMs for known illuminants;
constructing a coefficient vector, wherein the coefficient vector is based at least in part on an estimated white point of the image pixel data;
multiplying the set of CCM multiplier vectors with the coefficient vector to generate a determined CCM for the estimated white point; and
applying the determined CCM for the estimated white point to the image pixel data to transform the image pixel data into color-corrected image pixel data.

2. The non-transitory program storage device of claim 1, wherein the instructions stored thereon further cause the programmable control device to perform the act of:
calculating the estimated white point for the image pixel data.

3. The non-transitory program storage device of claim 1, wherein the image pixel data comprises color-balanced image pixel data.

4. The non-transitory program storage device of claim 1, wherein the set of CCM multiplier vectors is the same for all captured images.

5. The non-transitory program storage device of claim 1, wherein the act of constructing a set of CCM multiplier vectors comprises solving a general dimension reduction problem.

6. The non-transitory program storage device of claim 1, wherein the act of constructing a set of CCM multiplier vectors comprises minimizing an aggregate error value.

7. The non-transitory program storage device of claim 1, wherein the act of constructing a coefficient vector comprises utilizing a polynomial function based at least in part on a set of values representing the estimated white point.

8. The non-transitory program storage device of claim 7, wherein the polynomial function is a low order polynomial function.

9. The non-transitory program storage device of claim 1, wherein the coefficient vector comprises a lux factor.

10. An apparatus comprising:
an image sensor;
a programmable control device;
a memory coupled to the programmable control device, wherein instructions are stored in the memory, the instructions causing the programmable control device to perform a method comprising the acts of:
receiving image pixel data from an image captured by the image sensor;
obtaining a set of color correction matrix (CCM) multiplier vectors, wherein the set of CCM multiplier vectors is representative of a plurality of CCMs for known illuminants;
constructing a coefficient vector, wherein the coefficient vector is based at least in part on an estimated white point of the image pixel data;
multiplying the set of CCM multiplier vectors with the coefficient vector to generate an determined CCM for the estimated white point; and
applying the determined CCM for the estimated white point to the image pixel data to transform the image pixel data into color-corrected image pixel data.

11. The apparatus of claim 10, wherein the instructions further cause the programmable control device to:
calculate the estimated white point for the image pixel data.

12. The apparatus of claim 10, wherein the image pixel data comprises color-balanced image pixel data.

13. The apparatus of claim 10, wherein the set of CCM multiplier vectors is constructed only once for the apparatus.

14. The apparatus of claim 13, wherein the act of constructing the set of CCM multiplier vectors comprises solving a general dimension reduction problem.

15. The apparatus of claim 10, wherein the act of constructing a coefficient vector comprises utilizing a polynomial function based at least in part on a set of values representing the estimated white point.

16. The apparatus of claim 10, wherein the coefficient vector comprises a lux factor.

17. The apparatus of claim 10, wherein the determined CCM does not comprise an interpolation between on or more corner matrices.

18. A non-transitory program storage device, readable by a programmable control device comprising instructions stored thereon for causing the programmable control device to perform a method comprising the acts of:
obtaining a set of color correction matrix (CCM) multiplier vectors, wherein the set of CCM multiplier vectors comprises a set of values resulting from a deterministic process;
constructing a coefficient vector, wherein the coefficient vector is based at least in part on an estimated white point of image pixel data;
multiplying the set of CCM multiplier vectors with the coefficient vector to generate a determined CCM for the estimated white point; and
applying the determined CCM for the estimated white point to the image pixel data to transform the image pixel data into color-corrected image pixel data.

19. The non-transitory program storage device of claim 18, wherein the instructions stored thereon further cause the programmable control device to perform the act of:
calculating the estimated white point for the image pixel data.

20. The non-transitory program storage device of claim 18, wherein the deterministic process comprises the act of parameter fitting.

21. The non-transitory program storage device of claim 18, wherein the set of CCM multiplier vectors is the same for all captured images.

22. The non-transitory program storage device of claim 18, wherein the coefficient vector comprises a lux factor.

23. A method comprising the acts of:
receiving image pixel data from an image captured by an image sensor of an image capture device;
obtaining a set of color correction matrices (CCM) multiplier vectors, wherein the set of CCM multiplier vectors is representative of a plurality of CCMs for known illuminants;
constructing a coefficient vector, wherein the coefficient vector is based at least in part on an estimated white point of the image pixel data;
multiplying the set of CCM multiplier vectors with the coefficient vector to generate a determined CCM for the estimated white point; and
applying the determined CCM for the estimated white point to the image pixel data to transform the image pixel data into color-corrected image pixel data.

24. The method of claim 23, wherein the coefficient vector comprises a lux factor.

25. The method of claim 24, wherein the wherein the act of constructing a coefficient vector comprises utilizing a polynomial function based at least in part on a set of values representing the estimated white point.
